(19) United States
(12) Patent Application Publication
(10) Pub. No.: US 2022/0148008 A1
(43) Pub. Date: May 12, 2022

(54) SYSTEMS AND METHODS FOR OPERATING AN INTERACTIVE CUSTOMER SERVICE EXPERIENCE

(71) Applicant: Capital One Services, LLC, McLean, VA (US)

(72) Inventors: Vincent PHAM, Chicago, IL (US); Lee ADCOCK, Midlothian, VA (US); Nahid Farhady GHALATY, Fairfax, VA (US); Geeta SHYAMALA, Herndon, VA (US)

(73) Assignee: Capital One Services, LLC, McLean, VA (US)

(21) Appl. No.: 17/093,698

(22) Filed: Nov. 10, 2020

(51) Int. Cl. G06Q 30/00; G06F 40/279; G06N 20/00

(52) U.S. Cl. CPC G06Q 30/016; H04M 3/51; G06N 20/00; G06F 40/279

(57) ABSTRACT

A computer-implemented method for operating an interactive customer service system may include: receiving interaction information of a plurality of customer communications that were each serviced by a respective interaction unassociated with a predetermined interaction model; and in response to determining, based on the received information, that a threshold number of the communications have a common root cause: generating a further interaction model of a further interaction, based on interaction information of the customer communications having the common root cause, by employing a machine learning model trained, based on (1) sets of previous interaction information with respective common root causes as training data and (2) respective interactions corresponding to the respective common root causes as ground truth, to generate an output interaction model for a given set of interaction information of customer communications having a given common root cause; and configuring the interactive customer service system such that a subsequent customer communication having the common root cause is serviced by the further interaction associated with the further interaction model.

### TECHNICAL FIELD

Various embodiments of the present disclosure relate generally to operating an interactive customer service experience, and, more particularly, to systems and methods for automatically adapting between human and autonomous customer interactions.

### BACKGROUND

Many businesses, institutions, and other entities have enacted customer service systems and procedures to facilitate the servicing of what may be a large volume of communications from customers. For example, a call center or the like may include systems and/or staff dedicated to servicing incoming customer communications, e.g., via an interaction with the customer. Various efforts have been made to streamline customer service procedures, such as separating call center resources into segments dedicated to particular types of communications. Another effort includes predetermining interaction models for customer service agents or systems to use. For example, an agent or automated system may follow a script, decision tree, checklist, manual, or the like. Such models may provide an agent or system with materials or resources needed to service a communication, and thus may not only streamline the servicing of the communication, but also may facilitate standardization of how like communications are serviced.

However, conventional customer service solutions that rely on predetermined models are generally not robust to changes in circumstances. In one example, an assumption used as a basis for an interaction model may change over time. Thus, a predetermined model may gradually be less and less efficient at processing interactions. In another example, an event or the like may result in circumstances that may not be accounted for in a predetermined interaction model. In a further example, there may not be a predetermined interaction model for a particular type of interaction, and agents or systems able to handle such an interaction, e.g., without the aid of a predetermined model, may be unavailable or in limited supply.

Additionally, predetermined interaction models may negatively impact a customer's experience, especially when the predetermined interaction is autonomous, e.g., an automated phone tree or chat bot. In other words, even when an agent may be available to provide human interaction with a customer, the customer may be forced to nevertheless navigate through an automated system.

The present disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for operating an interactive customer service system.

In one aspect, an exemplary embodiment of a computer-implemented method for operating an interactive customer service system may include: receiving interaction information of a plurality of customer communications that were each serviced by a respective interaction unassociated with a predetermined interaction model; and in response to determining, based on the received information, that a threshold number of the communications have a common root cause: generating a further interaction model of a further interaction, based on interaction information of the customer communications having the common root cause, by employing a machine learning model trained, based on (1) sets of previous interaction information with respective common root causes as training data and (2) respective interactions corresponding to the respective common root causes as ground truth, to generate an output interaction model for a given set of interaction information of customer communications having a given common root cause; and configuring the interactive customer service system such that a subsequent customer communication having the common root cause is serviced by the further interaction associated with the further interaction model.

In another aspect, an exemplary embodiment of a service manager system for an interactive customer service system may include: a memory storing instructions and a machine learning model trained, based on (1) sets of previous interaction information with respective common root causes as training data and (2) respective interactions corresponding to the respective common root causes as ground truth, to generate an output interaction model for a given set of interaction information of customer communications having a given common root cause; and a processor operatively connected to the memory and configured to execute the instructions to perform a plurality of acts. The acts may include: receiving interaction information of a plurality of customer communications that were each serviced by a respective interaction unassociated with a predetermined interaction model; and in response to determining, based on the received interaction information, that a threshold number of the plurality of customer communications have a common root cause: generating a further interaction model of a further interaction by employing the machine learning model; and configuring the interactive customer service system such that a subsequent customer communication having the common root cause is serviced by the further interaction associated with the further interaction model.

In a further aspect, an exemplary embodiment of a computer-implemented method for operating an interactive customer service system may include: receiving interaction information of a plurality of customer communications that were each serviced by a respective interaction unassociated with a predetermined interaction model; determining, based on the received interaction information, that a threshold number of the plurality of customer communications have a common root cause, by: receiving event data; identifying a first plurality of words in the received event data; identifying a second plurality of words in the received interaction information; comparing the first plurality of words with the second plurality of words; identifying the common root cause based on the comparison; and identifying the threshold number of customer service communications associated with interaction information having words associated with the common root cause; and in response to determining that the threshold number of the plurality of customer communications have a common root cause: generating a further interaction model of a further interaction, based on interaction information of the customer communications having the common root cause, by employing a machine learning model trained, based on (1) sets of previous interaction information with respective common root causes as training data and (2) respective interactions corresponding to the respective common root causes as ground truth, to generate an output interaction model for a given set of interaction information of customer communications having a given common root cause; and configuring the interactive customer service system such that a subsequent customer communication having the common root cause is serviced by the further interaction associated with the further interaction model.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary computing environment for operating an interactive customer service system, according to one or more embodiments.

FIG. 2 depicts a flowchart of an exemplary method for operating an interactive customer service system, according to one or more embodiments.

FIG. 3 depicts a flowchart of an exemplary method for determining an event-based root cause for customer communications, according to one or more embodiments.

FIG. 4 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

As used herein, a “customer” generally encompasses any person or entity that may desire information, resolution of an issue, purchase of a product, or engage in any other type of interaction with a provider, e.g., via a customer service solution The term “interaction” generally encompasses any form of communication that may be used between a customer and a provider, e.g., telephone, text message, online chat, in person conversation, electronic mail, regular mail, etc. An “interaction model” generally encompasses a procedure, process, script, scheme, specification, decision tree, guideline, finite-state flow, or the like for use by the provider, e.g., an agent, a system of the provider, and/or an intermediary thereof, in interactions with a customer. Terms like “provider,” “merchant,” “vendor,” or the like generally encompass a person or entity that may offer and/or provide a product such as a good, service, benefit, or the like having ownership or other rights that may be transferred. The term “provider” additionally encompasses, for example, civil services that may be associated with rights, property, or obligations of a customer. The term “customer service” generally encompasses a system for interaction between a customer and a provider, e.g., to provide and/or receive information, assess and/or attempt resolution of an issue, facilitate a purchase of a product, or the like. The term “agent” generally encompasses a person that communicates with a customer on behalf of a provider to provide customer service.

A customer service solution may desire to receive and service customer interactions in a timely and efficient manner. However, the customer service solution may rely on predetermined interaction models, which may not be robust to changes in underlying assumptions, changes in circumstances due to an event, or circumstances not accounted for in a predetermined model. Further, the customer service solution may force a customer to unnecessarily navigate an automated system, and may negatively impact the customer's experience. Accordingly, improvements in technology relating to facilitating processed transactions to reduce interchange fees are needed.

In the following description, embodiments will be described with reference to the accompanying drawings. As will be discussed in more detail below, in various embodiments, systems and methods for operating an interactive customer service system, e.g., by automatically adapting between human and autonomous customer interactions, are described.

In an exemplary use case, a service manager system of an interactive customer service system may determine that servicing of one or more customer communications involved an interaction that was unassociated with a predetermined interaction model. In other words, the service manager system may determine that one or more aspects of the communications were unaccounted for or otherwise not in alignment with or fully serviceable via the one or more predetermined interaction models of the interactive customer service system. Further, the service manager system may determine that at least some, e.g., a threshold amount, of the communications unassociated with a predetermined interaction model have a common root cause. For example, an event may have occurred that results in circumstances not contemplated in the one or more predetermined interaction models of the interactive customer service system. In another example, a baseline assumption of the one or more predetermined interaction models of the interactive customer service system may be or may become less accurate over time. In response to such a determination, the service manager system may generate a further interaction model directed to communications having that root cause. The service machine may configure the interactive customer service system such that a subsequent customer request having the common root cause is serviced by a further interaction associated with the further interaction model.

In some instances, servicing a communication with an interaction unassociated with a predetermined interaction model includes an interaction with a human agent. In some instances, the further interaction associated with the further interaction model is autonomous. In this manner, the service manager system may enable the interactive customer service system to dynamically respond to changing circumstances, so that communications otherwise serviced by human agents may be automated on the fly, in real time, and/or without supervision or direct input from a human user.

In some embodiments, the service manager system may monitor a number of communications having the root cause over time, and may dynamically shift servicing of such communications between autonomous servicing, e.g., via the further interaction associated with the further interaction model, and human agent interaction servicing, e.g., via the interaction unassociated with a predetermined interaction model. In this manner, the amount of autonomous interactions via the interactive customer service system may be dynamically adjusted. For instance, a flow rate of communications with a particular root cause may fluctuate over time (e.g., the root cause may be seasonal, periodic, sporadic, random, etc.). In the presence of a low flow rate of communications with the particular root cause relative to agent availability, the service manager system may configure the interactive customer service system to route at least a portion of such communications to the human agents. In the presence of a high flow rate of such communications, the service manager system may configure the interactive customer service system to route at least a portion of such communications to the further interaction associated with the further interaction model.

In some instances, the service manager system may employ one or more machine learning models for one or more operations, e.g., generating the further interaction model, determining a root cause for one or more customer communications, etc. In some instances, the further interaction model may be and/or include a modification and/or combination of one or more portions of one or more predetermined interaction models.

In another exemplary use case, an event may occur that may be associated with a change in circumstances that may be unaccounted for in the one or more predetermined interaction models of an interactive customer service system. For example, a national crisis, such as emergence of a pandemic, may have an impact on people's ability to work and/or their financial circumstances. Event resources, e.g., news reports, blogs, social media posts, etc., may record and/or report information associated with the event. A service manager system may receive event data from such event resources, and parse information obtained from the received event data, e.g., via a natural language parsing algorithm, machine learning model, etc. The service manager system may compare the parsed information with interaction information associated with one or more customer communications in order to determine the root cause of the one or more communications, e.g., associate the root cause of the one or more communications with the event data.

For example, the service manager system may determine that subject matter pertaining to work interruption, lockdown, etc., may be associated with the pandemic event. Further, the service manager system may determine that interactions for servicing one or more customer communications unassociated with a predetermined interaction model also may have been associated with similar subject matter, and may associate the pandemic event with the root cause of the one or more communications. Additionally, the service manager system may generate and implement a further predetermined model that accounts for the circumstances arising from the event. For example, to account for the pandemic event, the further interaction model may provide a script or message that informs the customer about the provider's response to the event and/or actions available to assist the customer in view of the change in circumstances, e.g., a billing freeze, cash advance, or the like. The automatic and dynamic generation and implementation of such a further interaction model may reduce a bottleneck in the interactive customer service system and enable the interactive customer service system to adapt to such events in real time.

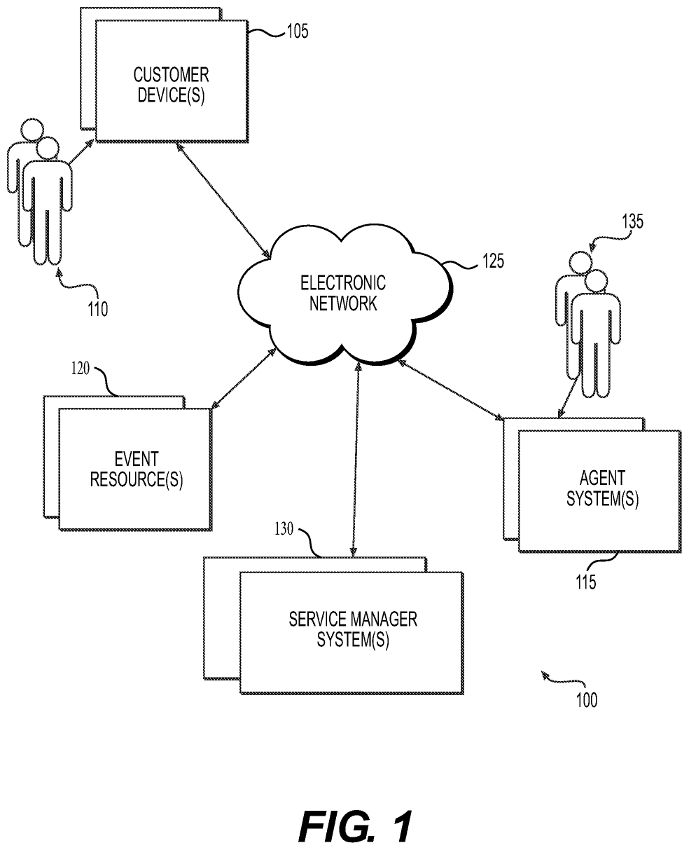

FIG. 1 depicts an exemplary computing environment 100 that may be utilized with techniques presented herein. In some embodiments, the computing environment 100 is, includes, and/or forms a portion of an interactive customer service system. One or more customer device(s) 105, one or more agent system(s) 115, and/or one or more event resource(s) 120 may communicate across an electronic network 125. Each customer device 105 may be associated with a respective customer 110. Each agent system 115 may be associated with a respective agent 135. As discussed in further detail below, one or more service manager system(s) 130 may communicate with one or more of the other systems and devices of the computing environment 100, e.g., via the electronic network 125.

The systems and devices of the computing environment 100 may communicate in any arrangement. As will be discussed herein, systems and/or devices of the computing environment 100 may communicate in order to operate an interactive customer service system, e.g., by automatically generating interaction models to account for circumstances and/or root causes unaccounted for or unassociated with predetermined interaction models of the interactive customer service system, or by automatically adapting between human and autonomous customer interactions, or the like.

The customer device 105 may include a computer system such as, for example, a desktop computer, a mobile device, etc. In an exemplary embodiment, the customer device 105 is a telephone, e.g., a cellphone, or the like. In some embodiments, the customer device 105 may include one or more electronic application(s), e.g., a program, plugin, etc., installed on a memory of the customer device 105 such as an electronic mail client, a text messaging application, a chat application, a voice communication application, or the like. In some embodiments, the electronic application(s) may be associated with one or more of the other components in the computing environment 100. For example, the electronic application(s) may include a portal for accessing and/or interacting with one or more of the other components in the computing environment 100.

The agent system 115, may include a computer system such as, for example, a desktop computer, a mobile device, etc. In an exemplary embodiment, the agent system 115 may include a telephone, e.g., a cellphone, or the like. In another exemplary embodiment, the agent system 115 may include a computer system, e.g., that interacts with, accesses, and/or acts as a portal to the service manager system 130. In an further exemplary embodiment, the agent system 115 includes a computer system and a telephone. Such a combination may enable the agent 135 to communicate with a customer 110, via the telephone, in conjunction with interacting with the service manager system 130, via the computer system, e.g., in order to execute an interaction model with the customer. In some embodiments, the agent system 115 may be configured to capture interaction information associated with interactions between the agent 135 and the customer 110. For example, in some embodiments, the agent system 115 may include a microphone, an electronic application configured to capture data associated with the interaction information, or the like. The agent system 115 may be configured store such interaction information, e.g., in a memory of the computing environment 100, and/or transmit such interaction information to another system or device in the computing environment 100. As used herein, “interaction information” may include captured data, e.g., audio data, video data, text communication data, etc. Interaction information may also include information extracted from, determined with, and/or parsed from captured data, e.g., via employing a natural language processing algorithm, context identification algorithm, or the like. Interaction information may also include information associated with actions taken by one or more of the agent 135, the agent system 115, the customer 110, the customer device 105, the service manager system 130, and/or any other system or device in the computing environment 100.

In various embodiments, the electronic network 125 may be a wide area network (“WAN”), a local area network (“LAN”), personal area network (“PAN”), or the like. In some embodiments, electronic network 125 includes the Internet, and information and data provided between various systems occurs online. “Online” may mean connecting to or accessing source data or information from a location remote from other devices or networks coupled to the internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). In some embodiments, the electronic network 125 includes or is in communication with a telecommunications network, e.g., a cellular network.

The event resource 120 may include one or more sources of event data available online, such as a website, e.g., a website associated with a news service, a blog, a social media website or post, or the like. In some embodiments, the event resource 120 may include a system configured to obtain event data, e.g., via an algorithm configured to access online resources and obtain information therefrom. In some embodiments, the event resource 120 may be configured to receive event data from a user, e.g., via a scanner, file transfer, file upload, user request or command, etc. In some embodiments, the event resource 120 may be configured to receive and/or obtain event data automatically, periodically, and/or in response to a signal, command, or request, e.g., from another computing device. In some embodiments, the event resource 120 include a memory for storing the event data. In some embodiments, the service manager system 130 and/or another system in the computing environment 100 includes and/or has access to a memory for storing the event data.

In some embodiments, the service manager system 130 may include or have access to a memory that stores instructions that are executable in order to operate the interactive customer service system of the computing environment 100. In some embodiments, the memory may store interaction information, event data, data associated with servicing of interactions such as one or more predetermined interaction models, or the like. In some embodiments, the memory may store one or more algorithms, such as a clustering algorithm, natural language processing algorithm, or the like. In some embodiments, the memory may store one or more machine learning models, e.g., machine learning models configured to generate an interaction model, and/or determine a root cause for one or more customer communications, etc. As used herein, a “machine learning model” generally encompasses instructions, algorithms, data, representations of data, or the like that are usable, for example, to correlate data and/or identify relationships between aspects of data. A “machine learning model” further generally encompasses a model that may be trained, e.g., via a set of training data and one or more labels assigned to the set of training data, to generate an output for a particular input. Any suitable type of machine learning model may be used such as, for example, a neural network, a deep learning network, a genetic algorithm, or the like, or combinations thereof.

As discussed in further detail below, the service manager system 130 may be configured to one or more of receive interaction information associated with customer communications, determine whether a threshold number of communications that are unassociated with a predetermined interaction model have a common root cause, generate a further interaction model associated with the common root cause, configure the interactive customer service system such that a subsequent communication with the common root cause is serviced via the further interaction model, and other operations.

Although depicted as separate components in FIG. 1, it should be understood that a component or portion of a component may, in some embodiments, be integrated with or incorporated into one or more other components. For example, a portion of the service manager system 130 may be provided to the customer device 105 as an electronic portal via the electronic application. At least a portion of agent system 115 may be integrated into the service manager system 130. At least a portion of the event resource 120 may be integrated into the service manager system 130. Any suitable arrangement of the various systems and devices of the computing environment 100 may be used. Further, it should be understood that data described as stored on a memory of a particular system or device in some embodiments, may be stored in another memory or distributed over a plurality of memories of one or more systems and/or devices in other embodiments.

In the methods below, various acts are described as performed or executed by a component from FIG. 1 such as the service manager system 130. However, it should be understood that in various embodiments, various components of the computing environment 100 discussed above may execute instructions or perform acts including the acts discussed below. Further, it should be understood that in various embodiments, various steps may be added, omitted, and/or rearranged in any suitable manner.

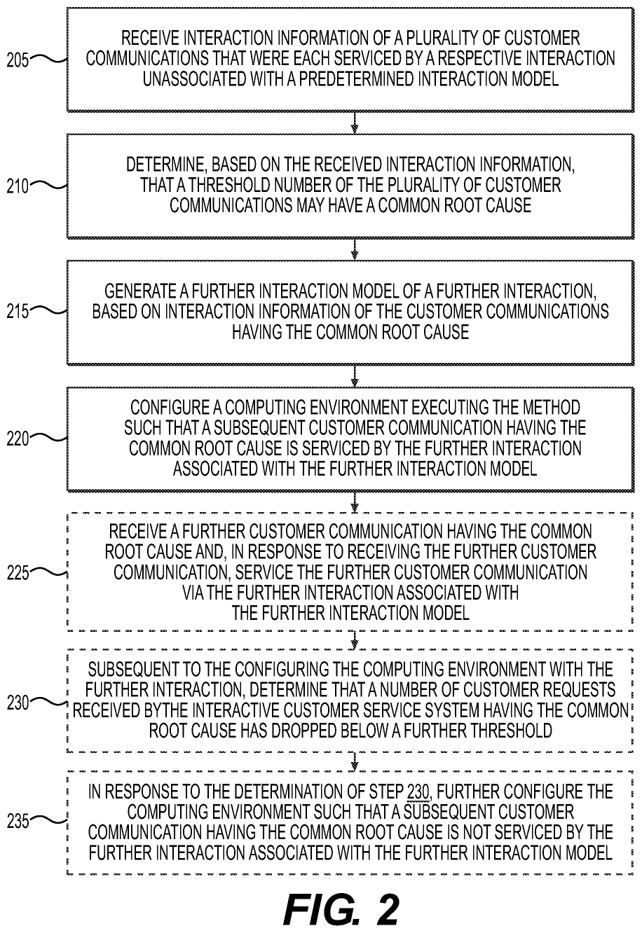

FIG. 2 illustrates an exemplary process for operating an interactive customer service system, e.g., via a service manager system 130, such as in the various examples discussed above. From time to time, one or more customers 110 may communicate with a provider via a customer service system, e.g., the computing environment 100. To service the one or more communications of the customer(s) 110, the interactive customer service system, e.g., an agent 135 and/or agent system 115 thereof, may perform one or more respective interactions with the customer(s) 110 either directly with the customer(s) 110 or via the customer device(s) 105 or the like.

One or more of the interactions may be associated with a predetermined interaction model. For example, an agent 135 may interact with the customer 110 by following a script, decision tree, one or more interactive prompts from the agent system 115, etc. In another example, the agent system 115 and/or the service manager system 130 may perform an autonomous interaction according to a set of instructions, a decision tree, a script, etc.

One or more of the interactions may be unassociated with a predetermined interaction model. For example, a predetermined interaction model implemented by one or more of the agent 135, agent system 115, and/or service manager system 130 may not fully service the customer 110's communication. In another example, fully servicing the customer 110's communication may require an action and/or interaction of the agent 135 that is not predetermined by any predetermined model.

It should be understood that a “fully serviced” communication does not necessarily require a resolved issue. Rather, the term “fully serviced” generally encompasses an interaction that is brought to completion, e.g., by one or more of providing information to the customer 110, receiving information from the customer 110, identifying an action to be taken by the customer and/or the provider, identifying an issue that is unresolved or an obligation that is unmet, so that the communication, at least for the moment, is concluded.

Referring to FIG. 2, at step 205, the service manager system 130 may receive interaction information of a plurality of customer communications that were each serviced by a respective interaction unassociated with a predetermined interaction model. Interaction information may include any information or data associated with the interaction between the customer 110 and the agent 135, agent system 115, and/or the service manager system 130 such as, for example, information requested from the customer associated with the customer 110's respective communication (e.g., by the agent 135, the agent system 115, and/or the service manager system 130), information provided by the customer 110, information requested from and/or provided by the agent 135, the agent system 115, and/or the service manager system 130 (e.g., by the customer 110), and/or information or data associated with at least one action taken by the agent 135, the agent system 115, and/or the service manager system 130 in response to the customer 110's communication.

In some embodiments, the respective interaction used to service one or more of the plurality of customer communications includes interaction between the customer 110 and the agent 135. In some embodiments, the interaction includes communication or interaction between the agent 135 and the agent system 115 and/or the service manager system 130. In some embodiments, at least a portion of the interaction is autonomous, e.g., performed by the agent system 115 and/or the service manager system 130 in an autonomous manner. In some embodiments, one or more of the customer communications includes one or more of a telephone communication, an electronic mail communication, a test message communication, an electronic application communication (e.g., an electronic chat application communication), or the like, or combinations thereof.

At step 210, the service manager system 130 may determine, based on the received interaction information, that a threshold number of the plurality of customer communications may have a common root cause. In some embodiments, the threshold number is predetermined. In some embodiments, the threshold number is determined dynamically. For example, in some embodiments, the threshold number is determined based on an availability of agents 135. For instance, when a relatively higher number of agents 135 are available, e.g., open to receive and service a communication, scheduled for working hours, etc., the threshold may be relatively higher, and vice versa. In some embodiments, the threshold number may be determined based on received event data, as discussed in further detail below.

A communication may have any suitable root cause. For example, a root cause may be associated with and/or arise from a circumstance associated with a particular geographic region, e.g., an economic condition, climate, regional tax, regional legal obligation or regulation, demographic aspect, marketing trend, or the like, or combinations thereof. In another example, a root cause may be associated with a circumstance associated with and/or arising from an occurrence of an event such as a weather event, social or public event, governmental event, holiday or calendar event, product release or recall, news report, or the like, or combinations thereof.

Any suitable technique of determining that customer communications have a common root cause may be used. For example, in some embodiments, the agent 135 from a respective interaction may submit an identification of the root cause for the associated communication. The service manager system 130 may receive such identifications of root causes of communications, and track the identifications of root causes over time.

In another example, in some embodiments, determining, based on the received interaction information, that a threshold number of the plurality of customer requests have the common root cause includes employing a first machine learning model. In some embodiments, the first machine learning model is trained to determine an output root cause for interaction information of an input customer communication, and the service manager system 130 may track output root causes over time. In some embodiments, the first machine learning model may be trained based on (1) interaction information of previously received customer communications as training data and (2) root causes associated with the previously received customer communications as ground truth. In some embodiments, training the first machine learning model may cause the machine learning model to learn how interaction information may be indicative of an associated root cause.

In a further example, determining, based on the received interaction information, that a threshold number of the plurality of customer requests have the common root cause may include employing a clustering algorithm to cluster the plurality of customer requests based on respective interaction information associated with each communication of the plurality of customer communications. For example, various portions of data in the interaction information for each communication may be assigned a respective value, such that the interaction information for each communication may be expressed as a respective vector. The respective vector may be used to define a location representative of each communication in an n-dimensional space. The clustering algorithm may be used to evaluate the n-dimensional space in order to identify communications that are clustered together. In another example, a natural language processing algorithm may be applied to the interaction information in order to, for example, identify words, phrases, or subject matter used in the interaction. Communications may be clustered together based on words, phrases, or subject matter in common. Any suitable technique for clustering the interaction information may be used. The service manager system 130 may identify a root cause for one or more cluster of communications, e.g., a cluster having at least the threshold number of communications unassociated with a predetermined interaction model.

Any suitable technique may be used to identify a root cause of a cluster. In some embodiments, identifying the root cause of a cluster may include employing a second machine learning model. The second machine learning model may be trained to determine an output root cause for interaction information of an input cluster of customer communications. In some embodiments, the second machine learning model may be trained based on (3) sets (e.g., clusters) of interaction information of previously received customer communications as training data and (4) root causes associated with the sets and/or with the communications as ground truth.

In an additional example, in some embodiments, determining, based on the received interaction information, that a threshold number of the plurality of customer requests have the common root cause may include determining or identifying a root cause based on event data, as discussed in further detail below. A root cause for one or more communications may be determined on the basis of any suitable factor or factors, and via any suitable technique or combination of techniques.

At step 215, the service manager system 130 may generate a further interaction model of a further interaction, based on interaction information of the customer communications having the common root cause. In some embodiments, the further interaction is at least partially autonomous, e.g., includes an autonomous portion and a portion executed by an agent 135 following a script, decision tree, or the like. In some embodiments, the further interaction model is fully autonomous.

In some embodiments, the further interaction model includes one or more of a portion of one or more predetermined interaction models, or a modification to one or more predetermined interaction models. A modification to a predetermined interaction model may include one or more of a request for information from a customer associated with the common root cause, an action to be performed in service of a customer request associated with the common root cause, or information to be provided to the customer associated with the common root cause. A portion of an interaction model may include, for example, a question for the customer, a response or statement made to the customer, a performance of an action (e.g., executing a purchase by the customer, modifying a profile of the customer, transmitting a message on behalf of the customer such as a complaint, order, request, selection, etc., or combinations thereof), a providing of one or more options to the customer (e.g., a phone tree, choice list, selectable buttons, etc.), or the like. In some embodiments, the service manager system 130 may include one or more predetermined portions that may not be associated with a particular interaction model. Such predetermined portions may act as building blocks for the service manager system 130 to assemble an interaction model.

In exemplary use cases, a further interaction model may include one or more of a response or follow up electronic mail to the customer, at least a portion of a script, decision tree, or the like or an option therefore for the agent 135, agent system 115, and/or service manager system 130, or the like. Any action that may be performed by the agent 135, agent system 115, and/or service manager system 130 may form a portion of the further interaction model.

Any suitable technique for generating a further interaction model may be employed. For example, in some embodiments, the service manager system 130 may include one or more templates for interactions. The service manager system 130 may select a template for the further interaction, e.g., a template determined to have a similarity to one or more of the root cause, information exchanged during the interactions associated with the root cause, and/or actions taken during the interactions. In an example, the service manage system 130 may employ a natural language processing algorithm, a context analysis algorithm, or the like to extract key and/or critical words or phrases from the interactions associated with the root cause, and may identify and/or select a template associated with the extracted key words or phrases. In another example, aspects of the templates may be expressed as a vector in the manner discussed above, and may be compared to the cluster(s) of communications in order to identify a similar template. In some embodiments, an agent 135 and/or another user may select a template for the further interaction model. The service manager system 130 may parse information from the interaction information of the customer communications having the common root cause, e.g., in order to identify one or more of information requested from or received by the customer 110, information requested from or received by the agent 135, agent system 115, and/or service manager system 130. The service manager system 130 may apply such identified information to the selected template to form the further interaction model.

In another example for generating the further interaction model, the service manager system 130 may employ a third machine learning model. The third machine learning model may be trained to generate an output interaction model for an input set of interaction information of customer communications having a given common root cause. The third machine learning model may be trained based on, for example, (1) sets of previous interaction information with respective common root causes as training data and (2) respective interactions, interaction models, and/or portions thereof corresponding to the respective common root causes as ground truth. In a further example, in some instances, the third machine learning model may be trained to extract and/or identify key or critical words or phrases from the input set of interaction information, and generate the output interaction model based on the extracted and/or identified words or phrases.

At step 220, the service manager system 130 may configure the computing environment 100, e.g., the interactive customer service system, the agent system 115, and/or the service manager system 130, such that a subsequent customer communication having the common root cause is serviced by the further interaction associated with the further interaction model. It should be understood that, in some embodiments, servicing the subsequent customer communication having the common root cause via the further interaction associated with the further interaction model may not require a determination that the subsequent communication has the common root cause. In some embodiments, the service manager system 130 may be configured, e.g., via the operation of step 220, such that the customer is automatically routed to the further interaction model during the course of the further interaction. For example, the configuring of the interactive customer service system at step 220 may add and/or re-arrange an option in a decision tree or the like that is selectable by the customer such that a customer initiating a subsequent communication having the common root cause is naturally routed to the further interaction model via selection of the option corresponding to the common root cause.

In some embodiments, the service manager system 130 may configure the interactive customer service system such that a portion of subsequent customer communications are serviced by the further interaction associated with the further interaction model. For example, in some embodiments, such portion may be a portion selected such that a remaining portion are not serviced by the further interaction associated with the further interaction model, e.g., such that they are serviced by an interaction unassociated with a predetermined interaction model, falls below the threshold number.

Optionally, at step 225, the computing environment 100, e.g., the customer service system and/or the service manager system 130 may receive a further customer communication having the common root cause and, in response to receiving the further customer communication, may service the further customer communication via the further interaction associated with the further interaction model. For example, the further communication may be serviced via the further interaction associated with the further interaction model instead of via an interaction unassociated with a predetermined interaction model. In other words, in some embodiments, the further interaction model may act as an additional predetermined interaction model for subsequent customer communications. Servicing the further customer communication via the further interaction and further interaction model, e.g., instead of an interaction unassociated with a predetermined interaction model, may streamline the servicing process, reduce one or more of time, personnel, resources, or the like to service the communication, and may increase a standardization to servicing of communications having the common root cause.

Optionally, at step 230, subsequent to the configuring the interactive customer service system with the further interaction, e.g., in step 220, the service manager system 130 may determine that a number of customer requests received by the interactive customer service system having the common root cause has dropped below a further threshold. In some embodiments, the further threshold is the same as the threshold from step 210. In some embodiments, the further threshold is a different threshold.

In some embodiments, as noted above, the service manager system 130 may track the receipt of customer communications and/or associated root causes over time. In some embodiments, the service manager system 130 may determine that, during a first period of time, receipt of communications all having a common root cause exceeded the threshold, and may determine that, during a second period of time, e.g., after the first period of time, that receipt of communications having the common root cause did not exceed the threshold. For example, an event giving rise to a root cause may have a limited duration, and/or a circumstance giving rise to a root cause may have a sporadic, periodic, or random occurrence, etc.

Optionally, at step 235, in response to the determination of step 230, the service manager system 130 may further configure the interactive customer service system or the like, e.g., in the manner of step 220, such that a subsequent customer communication having the common root cause is not serviced by the further interaction associated with the further interaction model. For example, in some embodiments, it may be preferable to service a communication with an agent 135 who may, for example, be able to offer a more personal and customized response than an autonomous system and/or an agent 135 bound strictly to an interaction model such as a script or the like. Thus, in some embodiments, in response to the number of customer communications during a period of time dropping below the threshold number, e.g., such that available agents 135 are able to timely service the incoming communications, the service manager system 130 may, for example, revert the configuration from step 220 so that the computing environment is configured to handle customer communications in a manner similar to prior to step 220.

In some embodiments, the method above, and/or portions thereof may be performed periodically, iteratively, or the like. For example, in some embodiments, the computing environment 100 may be configured and further configured, from time to time, as the number of customer communications having the common root cause may fluctuate over time. In some embodiments, such operation may enable the computing environment 100 to dynamically adapt to fluctuating flows of customer communications. In an exemplary use case, an interactive customer service system may be configured, e.g., by selection of the threshold number or the like, to prioritize servicing of customer communications with an agent 135 so long as a criteria is met, e.g., average time for a communication to be serviced, agent availability, etc. In response to such criteria not being met, for example, e.g., as indicated by the number of communications exceeding the threshold, the interactive customer service system may be configured to route at least a portion of the communications to the further interaction and further interaction model. In this manner, an interactive customer service system may, for example, service a communication via an agent 135 when possible to do so in compliance with the criteria, while also dynamically adapting to a more autonomous system in order to reduce an impact to customer experience.

As noted above, in some embodiments, a root cause may be associated with an occurrence of an event. Further, as also noted above, in some embodiments, the determination, based on the received interaction information, that a threshold number of the plurality of customer communications have the common root cause may be based on event data associated with the event.

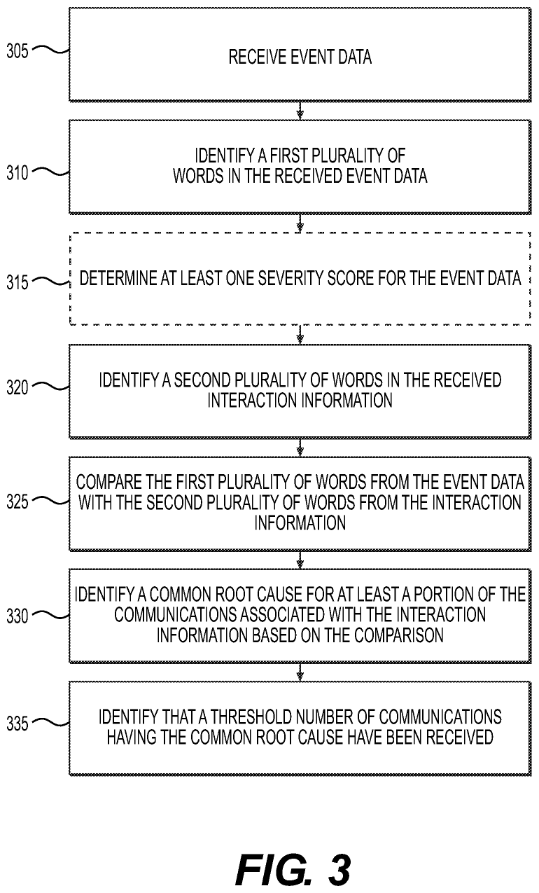

FIG. 3 depicts a flow diagram of an exemplary method of determining that a threshold number of a plurality of communications have a common root cause associated with an event. An event may occur. In one example, a storm or other weather event may occur. In another example, a public event such as a national pandemic may occur. One or more event resources 120 may include, store, transmit, or output information associated with the occurrence of the event. For example, an event resource 120 may generate, distribute, and/or store a news report, blog entry, or the like covering an event.

At step 305, the service manager system 130 may receive event data, e.g., from one or more event resources 120. In various embodiments, the service manager system 130 may periodically receive and/or request event data from the one or more event resources 120. In some embodiments, the service manager system 130 may receive and/or request event data from the one or more event resources 120 in response to an instruction or command. In some embodiments, one or more of the event resources 120 may be configured to transmit a notification and/or event data to the service manager system 130 in response to the occurrence of the event. Event data may include, for example, text, audio, image, and/or video content associated with one or more of a news report, blog post, social media post, marketing material, public announcement governmental communication or statement, climate data or a climate or weather report, or the like, or combinations thereof.

At step 310, the service manager system 130 may identify a first plurality of words in the received event data. Any suitable technique may be used to identify the first plurality of words. For example, the service manager system 130 may employ a speech-to-text algorithm, a natural language processing algorithm, or the like to identify words from spoken language utterances in the event data, e.g., a news report, video, etc. In another example, the service manager system 130 may employ an image analysis algorithm, e.g., a text identification algorithm, object identification algorithm, or the like, on one or more images in the event data. In some embodiments, identifying the first plurality of words includes determining a count of one or more of the first plurality of words. In some embodiments, the service manager system 130 may identify a predetermined quantity of words having the highest relative counts.

In some embodiments, the service manager system 130 may be configured to prune (e.g., remove, ignore, de-emphasize, or the like) one or more words from the first plurality of words. Words that may be pruned may include, for example, words having a count below a predetermined threshold, common words such as articles, transitions, or the like. In some embodiments, the service manager system 130 may include a predetermined list of one or more words to prune from the first plurality of words. In some embodiments, the service manager system 130 may include a predetermined list of one or more words to include in the first plurality of words.

Optionally, at step 315, the service manager system 130 may determine at least one severity score for the event data. In some embodiments, the server manager system 130 may include one or more event types and a predetermined list of one or more words associated with the one or more event types. The one or more event types may have a predetermined association with a level of severity and/or a severity score. In some embodiments, the at least one severity score may be based on one or more of an event type associated with one or more of the first plurality of words. In some embodiments, the at least one severity score may be based on a repetition count of one or more of the first plurality of words. For example, event data having a relatively high count of the word “disaster” may have a relatively higher severity score than event data having a relatively low count of the word “disaster.” In some embodiments, the threshold number of communications having the common root cause is based on the at least one severity score.

At step 320, the service manager system 130 may identify a second plurality of words in the received interaction information, e.g., the interaction information associated with a common root cause. In some embodiments, the service manager system 130 may employ one or more algorithms or machine learning models in order to identify the second plurality of words, such as those discussed in the examples above. In some embodiments, step 320 is performed in conjunction with, iteratively with, before, or after a step such as step 210 in the method of FIG. 2, e.g., an operation associated with identifying a root cause of a communication, determining a cluster of communications, identifying a common root cause of a cluster, or the like. For example, in some embodiments, the second plurality of words may be used to identify the root cause of a communication. In another example, the second plurality of words may include words from an identified cluster of communications.

At step 325, the service manager system 130 may compare the first plurality of words from the event data with the second plurality of words from the interaction information. For example, the service manager system 130 may compare counts of words, phrases, references to subject matter, or the like. In some embodiments, the service manager system 130 may perform a clustering algorithm, e.g., in the manner discussed above, on a combination of the first plurality of words and the second plurality of words.

At step 330, the service manager system 130 may identify a common root cause for at least a portion of the communications associated with the interaction information based on the comparison.

At step 335, the service manager system 130 may identify that a threshold number of communications having the common root cause have been received. For example, the service manager system 130 may identify that the threshold number of customer service communications associated with the received interaction information have words associated with the common root cause.

Although the processes discussed above with regard to FIGS. 2 and 3 pertain to interactive customer service systems, it should be understood that one or more aspects of the methods or features discussed above may be incorporated or adapted to a method involving any instance where a person may navigate a decision tree or the like during an interaction with another person or entity. For example, aspects of one or more of the examples or methods above may be adapted to making an insurance claim or other associated tasks. In another example, aspects of one or more of the examples or methods above may be adapted to a chat bot, an electronic assistant, a home automation interface, or the like.

It should be understood that embodiments in this disclosure are exemplary only, and that other embodiments may include various combinations of features from other embodiments, as well as additional or fewer features.

In general, any process or operation discussed in this disclosure that is understood to be computer-implementable, such as the process illustrated in FIGS. 2 and 3, may be performed by one or more processors of a computer system, such any of the systems or devices in the computing environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

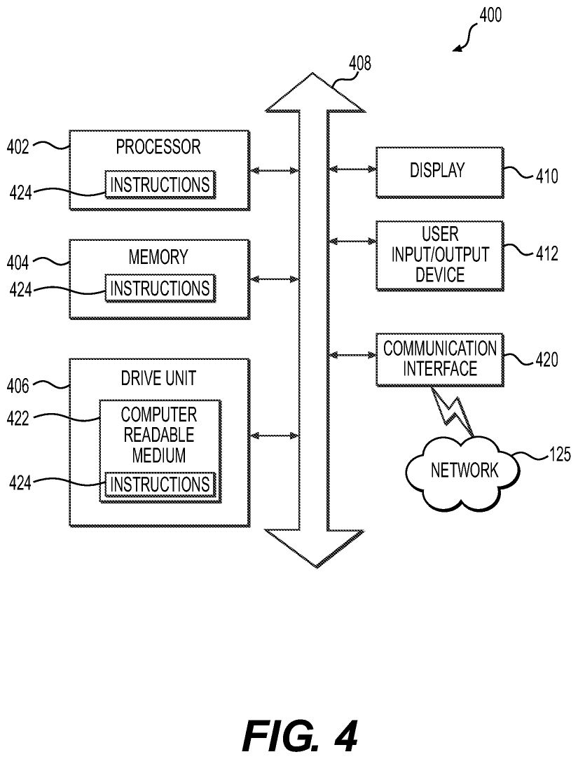

FIG. 4 is a simplified functional block diagram of a computer system 400 that may be configured as a device for executing the methods of FIGS. 2 and 3, according to exemplary embodiments of the present disclosure. FIG. 4 is a simplified functional block diagram of a computer system that may be configured as the service manager system 130 and/or another system according to exemplary embodiments of the present disclosure. In various embodiments, any of the systems (e.g., computer system 400) herein may be an assembly of hardware including, for example, a data communication interface 420 for packet data communication. The computer system 400 also may include a central processing unit (“CPU”) 402, in the form of one or more processors, for executing program instructions. The computer system 400 may include an internal communication bus 408, and a storage unit 406 (such as ROM, HDD, SDD, etc.) that may store data on a computer readable medium 422, although the computer system 400 may receive programming and data via network communications. The computer system 400 may also have a memory 404 (such as RAM) storing instructions 424 for executing techniques presented herein, although the instructions 424 may be stored temporarily or permanently within other modules of computer system 400 (e.g., processor 402 and/or computer readable medium 422). The computer system 400 also may include input and output ports 412 and/or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment 100, such as a desktop or laptop computer, an automobile entertainment system, a home entertainment system, etc. Also, the presently disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for operating an interactive customer service system, comprising:
receiving interaction information of a plurality of customer communications that were each serviced by a respective interaction unassociated with a predetermined interaction model; and
in response to determining, based on the received interaction information, that a threshold number of the plurality of customer communications have a common root cause:
generating a further interaction model of a further interaction, based on interaction information of the customer communications having the common root cause, by employing a machine learning model trained, based on (1) sets of previous interaction information with respective common root causes as training data and (2) respective interactions corresponding to the respective common root causes as ground truth, to generate an output interaction model for a given set of interaction information of customer communications having a given common root cause; and
configuring the interactive customer service system such that a subsequent customer communication having the common root cause is serviced by the further interaction associated with the further interaction model.

2. The method of claim 1, further comprising:
receiving a further customer communication having the common root cause; and
in response to receiving the further customer communication, servicing the further customer communication via the further interaction associated with the further interaction model.

3. The method of claim 2, wherein:
the respective interaction unassociated with a predetermined interaction model includes a human agent interaction; and
the further interaction associated with the further interaction model is autonomous.

4. The method of claim 3, further comprising:
subsequent to configuring the interactive customer service system with the further interaction, determining that a number of customer communications received by the interactive customer service system having the common root cause has dropped below a further threshold; and
in response to determining that the number of customer communications received by the interactive customer service system having the common root cause has dropped below the further threshold, further configuring the interactive customer service system such that a subsequent customer communication having the common root cause is not serviced by the further interaction associated with the further interaction model.

5. The method of claim 1, wherein the interaction information includes one or more of:
information requested by a human agent from a customer associated with at least one of the plurality of customer communications;
information provided by the customer; and
at least one action taken by the human agent in response to the at least one customer communication.

6. The method of claim 1, wherein determining, based on the received interaction information, that a threshold number of the plurality of customer communications have the common root cause includes employing a further machine learning model trained, based on (3) interaction information of previously received customer communications as training data and (4) root causes associated with the previously received customer communications as ground truth, to determine an output root cause for interaction information of a given customer communication.

7. The method of claim 1, wherein determining, based on the received interaction information, that a threshold number of the plurality of customer communications have the common root cause includes receiving an identification of a root cause for at least one of the plurality of customer communications from a human agent associated with the at least one customer communication.

8. The method of claim 1, wherein determining, based on the received interaction information, that a threshold number of the plurality of customer communications have the common root cause includes:
employing a clustering algorithm to cluster the plurality of customer communications based on respective interaction information associated with each communication of the plurality of customer communications; and
identifying a root cause of a cluster that includes at least the threshold number of customer communications.

9. The method of claim 8, wherein identifying the root cause of the cluster includes employing an additional machine learning model trained, based on (3) sets of interaction information of previously received customer communications as training data and (4) root causes associated with the sets as ground truth, to determine an output root cause for interaction information of a given cluster of customer communications.

10. The method of claim 8, wherein determining, based on the received interaction information, that a threshold number of the plurality of customer communications have the common root cause includes:
receiving event data;
identifying a first plurality of words in the received event data;
identifying a second plurality of words in the received interaction information;
comparing the first plurality of words with the second plurality of words;
identifying the common root cause based on the comparison; and
identifying the threshold number of customer service communications associated with interaction information having words associated with the common root cause.

11. The method of claim 10, further comprising:
determining at least one severity score for the event data based on one or more of:
an event type associated with one or more of the first plurality of words; or
a repetition count of one or more of the first plurality of words;
wherein the threshold number is based on the at least one severity score.

12. The method of claim 1, wherein the threshold number is based on an availability of human agents.

13. The method of claim 1, wherein the root cause is associated with one or more of:
a geographical region; or
an occurrence of a public event.

14. The method of claim 1, wherein the further interaction model includes:
the predetermined interaction model; and
a modification to the predetermined interaction model including one or more of a request for information from a customer associated with the common root cause, an action to be performed in service of a customer communication associated with the common root cause, or information to be provided to the customer associated with the common root cause.

15. The method of claim 1, wherein the plurality of customer communications includes one or more of a telephone communication, an electronic mail communication, a text message communication, a communication received via an electronic application, or combinations thereof.

16. A service manager system for an interactive customer service system, comprising:
a memory storing instructions and a machine learning model trained, based on (1) sets of previous interaction information with respective common root causes as training data and (2) respective interactions corresponding to the respective common root causes as ground truth, to generate an output interaction model for a given set of interaction information of customer communications having a given common root cause; and
a processor operatively connected to the memory and configured to execute the instructions to perform a plurality of acts, including:
receiving interaction information of a plurality of customer communications that were each serviced by a respective interaction unassociated with a predetermined interaction model; and
in response to determining, based on the received interaction information, that a threshold number of the plurality of customer communications have a common root cause:
generating a further interaction model of a further interaction by employing the machine learning model; and
configuring the interactive customer service system such that a subsequent customer communication having the common root cause is serviced by the further interaction associated with the further interaction model.

17. The service manager system of claim 16, wherein the acts further include:
receiving a further customer communication;
determining that the further customer communication has the common root cause; and
servicing the further customer communication via the further interaction associated with the further interaction model.

18. The service manager system of claim 17, wherein:
the respective interaction unassociated with a predetermined interaction model includes a human agent interaction; and
the further interaction associated with the further interaction model is autonomous.

19. The service manager system of claim 18, further comprising:
subsequent to configuring the interactive customer service system with the further interaction, determining that a number of customer communications received by the interactive customer service system having the common root cause has dropped below a further threshold; and
in response to determining that the number of customer communications received by the interactive customer service system having the common root cause has dropped below the further threshold, further configuring the interactive customer service system such that a subsequent customer communication having the common root cause is not serviced by the further interaction associated with the further interaction model.

20. A computer-implemented method for operating an interactive customer service system, comprising:
receiving interaction information of a plurality of customer communications that were each serviced by a respective interaction unassociated with a predetermined interaction model;
determining, based on the received interaction information, that a threshold number of the plurality of customer communications have a common root cause, by:
receiving event data;
identifying a first plurality of words in the received event data;
identifying a second plurality of words in the received interaction information;
comparing the first plurality of words with the second plurality of words;
identifying the common root cause based on the comparison; and
identifying the threshold number of customer service communications associated with interaction information having words associated with the common root cause; and
in response to determining that the threshold number of the plurality of customer communications have a common root cause:
generating a further interaction model of a further interaction, based on interaction information of the customer communications having the common root cause, by employing a machine learning model trained, based on (1) sets of previous interaction information with respective common root causes as training data and (2) respective interactions corresponding to the respective common root causes as ground truth, to generate an output interaction model for a given set of interaction information of customer communications having a given common root cause; and
configuring the interactive customer service system such that a subsequent customer communication having the common root cause is serviced by the further interaction associated with the further interaction model.
